(19) United States
(12) Patent Application Publication
(10) Pub. No.: US 2024/0097127 A1
(43) Pub. Date: Mar. 21, 2024

(54) NEGATIVE ELECTRODE FOR SECONDARY BATTERY, AND SECONDARY BATTERY

(71) Applicant: MURATA MANUFACTURING CO., LTD., Kyoto (JP)

(72) Inventor: Yosuke KOIKE, Kyoto (JP)

(21) Appl. No.: 18/509,630

(22) Filed: Nov. 15, 2023

Related U.S. Application Data
(63) Continuation of application No. PCT/JP2022/007291, filed on Feb. 22, 2022.

(30) Foreign Application Priority Data
May 18, 2021 (JP) 2021-084128

(51) Int. Cl. H01M 4/58; H01M 10/0525

(52) U.S. Cl. CPC H01M 4/58; H01M 10/0525; H01M 2004/027

(57) ABSTRACT

A secondary battery includes a positive electrode, a negative electrode, and an electrolytic solution. The negative electrode includes first fiber parts, covering parts, and second fiber parts, and has voids. The first fiber parts are coupled to each other to thereby form a three-dimensional mesh structure having the voids. The first fiber parts each include carbon as a constituent element. The covering parts each cover a surface of corresponding one of the first fiber parts, and each include silicon as a constituent element. At least some of the second fiber parts are each coupled to a surface of any of the covering parts. The second fiber parts each include carbon as a constituent element. The first fiber parts have an average fiber diameter that is greater than or equal to 10 nm and less than or equal to 8000 nm. The second fiber parts have an average fiber diameter that is greater than or equal to 1 nm and less than or equal to 300 nm. The negative electrode has a void rate that is greater than or equal to 40 vol % and less than or equal to 70 vol %.

### CROSS REFERENCE TO RELATED APPLICATIONS

The present application is a continuation of PCT patent application no. PCT/JP2022/007291, filed on Feb. 22, 2022, which claims priority to Japanese patent application no. 2021-084128, filed on May 18, 2021, the entire contents of which are incorporated herein by reference.

### BACKGROUND

The present technology relates to a negative electrode for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte. A configuration of the secondary battery has been considered in various ways.

Specifically, as a material to be included in a negative electrode for a lithium-ion secondary battery, a carbonaceous conductive porous substrate, a conductive material (e.g., a carbon nanotube), and an active material (e.g., silicon) are used, and a porosity (a void rate) of the negative electrode is defined.

As a material to be included in a negative electrode for a lithium-ion secondary battery, a conducting substrate such as carbon fibers covered with, for example, silicon, is used and a content (weight ratio) of silicon in the negative electrode is defined.

As a material to be included in a negative electrode for a lithium-ion secondary battery, a composite material including a core (nano-carbon) and a shell (nano-silicon) is used and a void rate of the composite material is defined.

### SUMMARY

The present technology relates to a negative electrode for a secondary battery, and a secondary battery.

Consideration has been given in various ways regarding a configuration of a secondary battery; however, an initial capacity characteristic, a swelling characteristic, and a cyclability characteristic of the secondary battery still remain insufficient. Accordingly, there is room for improvement in terms thereof

It is therefore desirable to provide a negative electrode for a secondary battery, and a secondary battery that each make it possible to achieve a superior initial capacity characteristic, a superior swelling characteristic, and a superior cyclability characteristic.

A negative electrode for a secondary battery according to an embodiment of the present technology includes first fiber parts, covering parts, and second fiber parts, and has voids. The first fiber parts are coupled to each other to thereby form a three-dimensional mesh structure having the voids. The first fiber parts each include carbon as a constituent element. The covering parts each cover a surface of corresponding one of the first fiber parts, and each include silicon as a constituent element. At least some of the second fiber parts are each coupled to a surface of any of the covering parts. The second fiber parts each include carbon as a constituent element. The first fiber parts have an average fiber diameter that is greater than or equal to 10 nm and less than or equal to 8000 nm. The second fiber parts have an average fiber diameter that is greater than or equal to 1 nm and less than or equal to 300 nm. The negative electrode has a void rate that is greater than or equal to 40 vol % and less than or equal to 70 vol %.

A secondary battery according to an embodiment of the present technology includes a positive electrode, a negative electrode, and an electrolytic solution. The negative electrode has a configuration similar to the configuration of the negative electrode for a secondary battery according to an embodiment of the present technology described above.

A description will be given later as to details (e.g., definitions and calculation procedures) of each of the “average fiber diameter of the first fiber parts”, the “average fiber diameter of the second fiber parts”, and the “void rate” described above.

According to the negative electrode for a secondary battery or the secondary battery of

an embodiment of the present technology, the negative electrode for a secondary battery includes the first fiber parts, the covering parts, and the second fiber parts described above, and has the voids. In addition, the above-described conditions are satisfied regarding the average fiber diameter of the first fiber parts, the average fiber diameter of the second fiber parts, and the void rate. This makes it possible to achieve a superior initial capacity characteristic, a superior swelling characteristic, and a superior cyclability characteristic.

Note that effects of the present technology are not necessarily limited to those described herein and may include any of a series of suitable effects in relation to the present technology.

### BRIEF DESCRIPTION OF THE FIGURES

FIG. 1 is a schematic diagram illustrating a configuration of a negative electrode for a secondary battery according to an embodiment of the present technology.

FIG. 2 is an enlarged sectional diagram illustrating a configuration of each of a large-diameter carbon fiber part, a small-diameter carbon fiber part, and a covering part illustrated in FIG. 1.

FIG. 3 is a perspective diagram illustrating a configuration of a secondary battery according to an embodiment of the present technology.

FIG. 4 is an enlarged sectional diagram illustrating a configuration of a battery device illustrated in FIG. 3.

FIG. 5 is a sectional diagram illustrating a configuration of a negative electrode for a secondary battery according to an embodiment.

FIG. 6 is a block diagram illustrating a configuration of an application example of the secondary battery.

### DETAILED DESCRIPTION

One or embodiments of the present technology are described below in further detail including with reference to the drawings.

A description is given first of a negative electrode for a secondary battery (hereinafter, simply referred to as a “negative electrode”) according to an embodiment of the present technology. The negative electrode is to be used in a secondary battery, which is an electrochemical device. However, the negative electrode may be used in any of electrochemical devices other than the secondary battery. Such other electrochemical devices are not particularly limited in kind, and specific examples thereof include a capacitor.

In the electrochemical device such as the secondary battery described above, the negative electrode allows for insertion of an electrode reactant into the negative electrode and extraction of the electrode reactant from the negative electrode upon an electrode reaction. The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

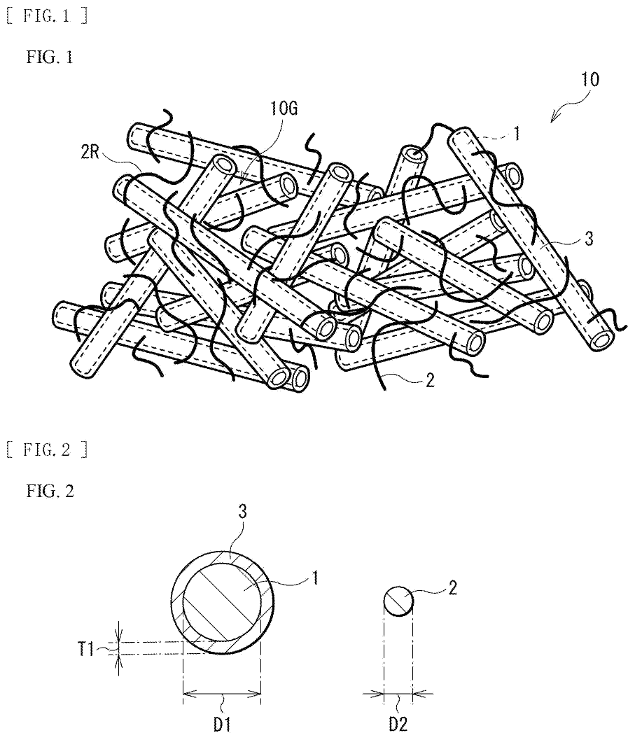

FIG. 1 schematically illustrates a configuration of a negative electrode 10 as an example of the negative electrode. FIG. 2 illustrates an enlarged sectional configuration of each of a large-diameter carbon fiber part 1, a small-diameter carbon fiber part 2, and a covering part 3 illustrated in FIG. 1. Note that FIG. 2 illustrates a section of each of the large-diameter carbon fiber part 1, the small-diameter carbon fiber part 2, and the covering part 3 intersecting a longitudinal direction of corresponding one of the large-diameter carbon fiber part 1 and the small-diameter carbon fiber part 2.

As illustrated in FIG. 1, the negative electrode 10 includes multiple large-diameter carbon fiber parts 1, multiple small-diameter carbon fiber parts 2, and multiple covering parts 3, and has multiple voids 10G. That is, the negative electrode 10 does not include a current collector (hereinafter referred to as a “metal current collector”) such as a metal foil. The negative electrode 10 is thus a metal current collector-less electrode.

As illustrated in FIG. 1, the large-diameter carbon fiber parts 1 are first fiber parts that have an average fiber diameter AD1 greater than an average fiber diameter AD2 of the small-diameter carbon fiber parts 2. As illustrated in FIG. 2, the large-diameter carbon fiber parts 1 each have a fiber diameter D1. The large-diameter carbon fiber parts 1 are coupled to each other to thereby form a three-dimensional mesh structure having the voids 10G described above.

For simplifying illustration, FIG. 1 illustrates a case where the large-diameter carbon fiber parts 1 each have a linear shape. However, a state (the shape) of each of the large-diameter carbon fiber parts 1 is not particularly limited, and is thus not limited to the linear shape. The large-diameter carbon fiber parts 1 may each be curved, branched, or in a mixture state including two or more of such different shapes.

Here, the large-diameter carbon fiber parts 1 are coupled to each other to form the three-dimensional mesh structure, as described above. More specifically, the large-diameter carbon fiber parts 1 are randomly entangled with each other. Note that the large-diameter carbon fiber parts 1 may be bound to each other via an unillustrated carbide such as a polymer compound, or may be coupled to each other via one or more of the small-diameter carbon fiber parts 2. As a result, the large-diameter carbon fiber parts 1 have multiple junctions, and any two of the large-diameter carbon fiber parts 1 are electrically continuous with each other at each junction.

The average fiber diameter AD1 of the large-diameter carbon fiber parts 1 is in a range from 10 nm to 8000 nm both inclusive. A reason for this is that this allows the large-diameter carbon fiber parts 1 constituting a main part of the negative electrode 10 to be sufficiently large in fiber diameter D1. As a result, a sufficient electrically conductive network (three-dimensional mesh structure) is formed inside the negative electrode 10, which improves electrical conductivity of the negative electrode 10.

A procedure to calculate the average fiber diameter AD1 is as described below. First, the negative electrode 10 is collected, following which the negative electrode 10 is washed with, for example, a washing solvent such as dimethyl carbonate. Note that when a secondary battery including the negative electrode 10 has been acquired, the negative electrode 10 is collected by disassembling the secondary battery. Thereafter, the negative electrode 10 is cut by means of, for example, an ion milling apparatus to thereby cause a section of the negative electrode 10 to become exposed.

Thereafter, the section of the negative electrode 10 is observed by means of a scanning electron microscope (SEM) or a transmission electron microscope (TEM) to thereby acquire a result of observation (an observation image) of the section. The large-diameter carbon fiber parts 1 are thus identifiable in the observation image. Observation conditions including, without limitation, an acceleration voltage and a magnification may be set as desired. Thereafter, any twenty large-diameter carbon fiber parts 1 are selected, following which the respective fiber diameters D1 of the twenty large-diameter carbon fiber parts 1 are measured. Lastly, an average value of the twenty fiber diameters D1 is calculated as the average fiber diameter AD1.

Note that an average of respective fiber lengths of the large-diameter carbon fiber parts 1 is not particularly limited. A reason for this is that as long as the large-diameter carbon fiber parts 1 having the above-described average fiber diameter AD1 are coupled to each other, a sufficient electrically conductive network (three-dimensional mesh structure) is formed regardless of the fiber lengths.

The large-diameter carbon fiber parts 1 each include carbon as a constituent element. Thus, the large-diameter carbon fiber parts 1 each include what is called a carbon-containing material. The term “carbon-containing material” is a generic term for a material that includes carbon as a constituent element.

Specifically, the large-diameter carbon fiber parts 1 include a carbon paper. A reason for this is that this allows the large-diameter carbon fiber parts 1 to be sufficiently coupled to each other and to be sufficiently large in average fiber diameter AD1, thus allowing for formation of a sufficient electrically conductive network (three-dimensional mesh structure).

Note that the large-diameter carbon fiber parts 1 may include a material that is processed to allow multiple fibers of a fibrous carbon material having the above-described average fiber diameter AD1 to form a three-dimensional mesh structure. The kind of the fibrous carbon material is not particularly limited, and specific examples thereof include a vapor-grown carbon fiber (VGCF) and a carbon nanofiber (CNF). Other possible kinds of the fibrous carbon material include a multi-walled carbon nanotube (a multi-wall carbon nanotube (MWCNT)) such as a double-walled carbon nanotube (a double-wall carbon nanotube (DWCNT)).

As illustrated in FIG. 1, the small-diameter carbon fiber parts 2 are second fiber parts that have the average fiber diameter AD2 smaller than the average fiber diameter AD1 of the large-diameter carbon fiber parts 1. As illustrated in FIG. 2, the small-diameter carbon fiber parts 2 each have a fiber diameter D2. Here, the small-diameter carbon fiber parts 2 are each fixed on a surface of any of the covering parts 3, and are thus each coupled to the surface of any of the covering parts 3.

For simplifying illustration, FIG. 1 illustrates a case where the small-diameter carbon fiber parts 2 each have a linear shape. However, a state (the shape) of each of the small-diameter carbon fiber parts 2 is not particularly limited, as with the state of each of the large-diameter carbon fiber parts 1 described above.

A reason why the negative electrode 10 includes the small-diameter carbon fiber parts 2 together with the large-diameter carbon fiber parts 1 is that an electrically conductive network is formed by the large-diameter carbon fiber parts 1 and in addition, a denser electrically conductive network is formed by the small-diameter carbon fiber parts 2, which markedly improves the electrical conductivity of the negative electrode 10.

In particular, some or all of the small-diameter carbon fiber parts 2, which are denoted as small-diameter carbon fiber parts 2R, are each preferably coupled to two or more covering parts 3. A reason for this is that in such a case, the two or more covering parts 3 are electrically coupled to each other via one or more small-diameter carbon fiber parts 2R. This results in a denser electrically conductive network, which further improves the electrical conductivity of the negative electrode 10.

The average fiber diameter AD2 of the small-diameter carbon fiber parts 2 is smaller than the average fiber diameter AD1 of the large-diameter carbon fiber parts 1 described above, and is specifically in a range from 1/10000 to ½ both inclusive, preferably in a range from 1/300 to ⅕ both inclusive, of the average fiber diameter AD1.

More specifically, the average fiber diameter AD2 is in a range from 1 nm to 300 nm both inclusive. A reason for this is that this allows the average fiber diameter AD2 to be sufficiently small relative to the average fiber diameter AD1 in a system in which the large-diameter carbon fiber parts 1 and the small-diameter carbon fiber parts 2 coexist, and thus makes it easier for the small-diameter carbon fiber parts 2 to be dispersed in the negative electrode 10. As a result, a denser electrically conductive network is formed by the small-diameter carbon fiber parts 2, which further improves the electrical conductivity of the negative electrode 10.

A procedure to calculate the average fiber diameter AD2 is similar to the procedure to calculate the average fiber diameter AD1 described above, except that the respective fiber diameters D2 of any twenty small-diameter carbon fiber parts 2 are measured and thereafter an average value of the twenty fiber diameters D2 is obtained as the average fiber diameter AD2. Note that when the fiber diameters D2 are small, the TEM is preferably used rather than the SEM to observe the section of the negative electrode 10.

Note that an average of respective fiber lengths of the small-diameter carbon fiber parts 2 is not particularly limited. A reason for this is that as long as the small-diameter carbon fiber parts 2 having the above-described average fiber diameter AD2 are present in the negative electrode 10, a dense electrically conductive network is formed regardless of the fiber lengths.

The small-diameter carbon fiber parts 2 each include carbon as a constituent element. Thus, the small-diameter carbon fiber parts 2 each include the carbon-containing material, as with the large-diameter carbon fiber parts 1.

Specifically, the small-diameter carbon fiber parts 2 each include a fibrous carbon material such as a carbon nanotube, a vapor-grown carbon fiber (VGCF), or a carbon nanofiber (CNF). A reason for this is that this makes it easier for the small-diameter carbon fiber parts 2 to be sufficiently dispersed in the negative electrode 10 and makes it easier to form a dense electrically conductive network.

The carbon nanotube is not particularly limited in kind, and may be a single-walled carbon nanotube (SWCNT) or a multi-walled carbon nanotube (MWCNT). Specific examples of the multi-walled carbon nanotube include a double-walled carbon nanotube (DWCNT).

In particular, the small-diameter carbon fiber parts 2 each preferably include the single-walled carbon nanotube, the vapor-grown carbon fiber, or both. A reason for this is that in such a case, the average fiber diameter AD2 becomes sufficiently small and accordingly, the small-diameter carbon fiber parts 2 are sufficiently dispersed in the negative electrode 10 and a denser electrically conductive network is formed.

As illustrated in FIG. 1, the covering parts 3 each cover a surface of corresponding one of the large-diameter carbon fiber parts 1. As illustrated in FIG. 2, the covering parts 3 each have a thickness T1.

The covering part 3 may entirely cover the surface of the large-diameter carbon fiber part 1, or may partially cover the surface of the large-diameter carbon fiber part 1. In the latter case, multiple covering parts 3 may cover the surface of the large-diameter carbon fiber part 1 at multiple locations separate from each other. For simplifying illustration, FIG. 1 illustrates a case where the covering parts 3 each entirely cover the surface of corresponding one of the large-diameter carbon fiber parts 1.

As a result, the large-diameter carbon fiber parts 1 having the relatively large average fiber diameter AD1 have their surfaces covered with the respective covering parts 3, whereas the small-diameter carbon fiber parts 2 having the relatively small average fiber diameter AD2 have their surfaces covered with no covering parts 3.

The covering parts 3 have an average thickness AT1 that is preferably in a range from 2.8 nm to 1300 nm both inclusive, in particular, although not particularly limited thereto. A reason for this is that in such a case, the covering parts 3 cover the surfaces of the large-diameter carbon fiber parts 1 by sufficiently large amounts, which makes it possible to obtain a sufficient energy density at the negative electrode 10 while ensuring the electrical conductivity of the negative electrode 10.

A procedure to calculate the average thickness AT1 is as described below. First, an observation result (an observation image) of a section of the negative electrode 10 is acquired by a procedure similar to the procedure used when calculating the average fiber diameter AD1 described above. Thereafter, any twenty covering parts 3 are selected, following which the respective thicknesses T1 of the twenty covering parts 3 are measured. Note that when a single covering part 3 has different thicknesses T1 at different positions thereon, a maximum value of the thicknesses T1 is taken. Lastly, an average value of the twenty thicknesses T1 is calculated as the average thickness AT1.

Further, the covering parts 3 each include silicon as a constituent element. Thus, the covering parts 3 each include what is called a silicon-containing material. A reason for this is that a high energy density is obtainable owing to superior electrode-reactant insertability and superior electrode-reactant extractability of silicon.

The term “silicon-containing material” is a generic term for a material that includes silicon as a constituent element. The silicon-containing material may thus be a simple substance of silicon, a silicon alloy, a silicon compound, a mixture of two or more thereof, or a material including one or more phases thereof. Note that the simple substance of silicon may include a small amount of impurity. In other words, purity of the simple substance of silicon is not limited to 100%. Examples of the impurity include an impurity that is unintentionally included during a process of manufacturing the simple substance of silicon, and an oxide that is unintentionally formed due to oxygen in the atmosphere. The impurity content of the simple substance of silicon is preferably as low as possible, and is more preferably 5 wt % or less.

The silicon alloy includes any one or more of metallic elements including, without limitation, tin, nickel, copper, iron, cobalt, manganese, zinc, indium, silver, titanium, germanium, bismuth, antimony, and chromium, as one or more constituent elements other than silicon. The silicon compound includes any one or more of non-metallic elements including, without limitation, carbon and oxygen, as one or more constituent elements other than silicon. Note that the silicon compound may further include, as one or more constituent elements other than silicon, any one or more of the series of metallic elements described above in relation to the silicon alloy.

Specific examples of the silicon alloy include Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, and SiC. Note that a composition of the silicon alloy, i.e., a mixture ratio between silicon and the one or more metallic elements, may be varied as desired.

Specific examples of the silicon compound include SiB₄, SiB₆, Si₃N₄, Si₂N₂O, SiOᵥ (where 0<v≤2), and LiSiO. Note that “v” may be in the following range: 0.2<v<1.4.

The silicon-containing material is preferably a simple substance of silicon, in particular. A reason for this is that a higher energy density is obtainable. In this case, a silicon content of each of the covering parts 3, that is, the content (purity) of silicon in the silicon-containing material, is preferably 80 wt % or more, and more preferably in a range from 80 wt % to 100 wt % both inclusive, in particular, although not particularly limited thereto. A reason for this is that a markedly high energy density is obtainable.

A weight proportion M (wt %), i.e., a proportion of a weight M3 of the covering parts 3 to a sum of a weight M1 of the large-diameter carbon fiber parts 1, a weight M2 of the small-diameter carbon fiber parts 2, and the weight M3 of the covering parts 3, is preferably in a range from 40 wt % to 76 wt % both inclusive, in particular, although not particularly limited thereto. A reason for this is that such a value range helps to achieve an appropriate relation between the weight of a carbon component (the large-diameter carbon fiber parts 1 and the small-diameter carbon fiber parts 2) and the weight of a silicon component (the covering parts 3) in the negative electrode 10, and thus helps to obtain a sufficient energy density while ensuring the electrical conductivity. The weight proportion M is calculable in accordance with the following calculation expression: M=[M3/(M1+M2+M3)]×100.

A procedure to calculate the weight proportion M is as described below. First, the negative electrode 10 is collected, following which the negative electrode 10 is washed with a washing solvent such as dimethyl carbonate. Thereafter, the negative electrode 10 is analyzed by thermogravimetry-differential thermal analysis (TG-DTA) to thereby determine the weights M1, M2, and M3. Note that any TG-DTA apparatus may be used to analyze the negative electrode 10.

In the analysis of the negative electrode 10, a weight loss that results when a heating temperature is increased to about 450° C. corresponds to a weight of the electrolytic solution, a binder, etc., and a weight loss that results when the heating temperature is increased to a range of about 450° C. to about 1350° C. corresponds to the weight of the carbon component, i.e., the weights M1 and M2 of the large-diameter carbon fiber parts 1 and the small-diameter carbon fiber parts 2. As a result, the weight of the remaining component corresponds to the weight of the silicon component, i.e., the weight M3 of the covering parts 3.

Note that the above-described temperature (i.e., about 450° C.) at which the weight loss related to the electrolytic solution, etc. is detectable can vary depending on the kind of the binder. Specifically, when the binder is polyvinylidene difluoride, its extinction temperature is about 460° C., assuming that a local minimum of a differential curve of the DTA corresponds to the extinction temperature.

Lastly, the weight proportion M is calculated in accordance with the foregoing calculation expression using the weights M1, M2, and M3.

Note that although not specifically illustrated here, a portion or all of the surface of the covering part 3 may be further covered with a covering layer. The covering layer includes any one or more of electrically conductive materials including, without limitation, the carbon-containing material and a metal material. A reason for this is that this further improves the electrical conductivity of the negative electrode 10. Details of the carbon-containing material are as described above. The metal material is not particularly limited in kind.

When forming the covering layer, for example, a silane coupling agent and a polymer-based material are used. A reason for this is to sufficiently cover the surface of the covering part 3 by using the covering layer. Covering the surface of the covering part 3 sufficiently by using the covering layer suppresses a decomposition reaction of the electrolytic solution at the surface of the covering part 3 including the silicon-containing material.

As described above, the negative electrode 10 includes the three-dimensional mesh structure formed by the large-diameter carbon fiber parts 1, and thus has the voids 10G.

A void rate R of the negative electrode 10 determined based on the voids 10G is in a range from 40 vol % to 70 vol % both inclusive. A reason for this is that this allows the voids 10G to be present in an appropriate amount in the negative electrode 10, and accordingly, even if the covering parts 3 including the silicon-containing material each undergo expansion and contraction upon charging and discharging, the voids 10G help to appropriately mitigate an internal stress (distortion) resulting from the expansion and contraction. As a result, the expansion and contraction of the covering parts 3 is suppressed even upon repeated charging and discharging, and degradation of the negative electrode 10 is thus suppressed. Examples of the degradation of the negative electrode 10 include damage to or breakage of any of the large-diameter carbon fiber parts 1, damage to or breakage of any of the small-diameter carbon fiber parts 2, and a collapse or falling-off of any of the covering parts 3.

A procedure to calculate the void rate R is as described below. By a procedure similar to that used in calculating the average fiber diameter AD1 described above, the negative electrode 10 is collected and washed, following which a three-dimensional image of the negative electrode 10 is acquired with a focused ion beam scanning electron microscope (FIB-SEM) to thereby calculate the void rate R based on the three-dimensional image by means of image analysis processing. Usable in the image analysis processing is, for example, GeoDict, comprehensive package software for innovative material development available from Math2Market GmbH.

Note that the negative electrode 10 may further include any one or more of other materials.

Such other materials are not particularly limited in kind, and specific examples thereof include a binder. A reason for this is that the large-diameter carbon fiber parts 1, the small-diameter carbon fiber parts 2, and the covering parts 3 are firmly couplable to each other via the binder, which allows for formation of a firm electrically conductive network.

The binder includes any one or more of polymer compounds. Specific examples of the polymer compounds include polyimide, polyvinylidene difluoride, polyacrylic acid, a styrene-butadiene rubber, and carboxymethyl cellulose. When the negative electrode 10 includes the binder, some of the small-diameter carbon fiber parts 2 may each be coupled to the surface of none of the covering parts 3, and may be free.

The negative electrode 10 is manufactured by a procedure described below. Described here is a case of using a carbon paper as the large-diameter carbon fiber parts 1.

First, a carbon paper that includes the large-diameter carbon fiber parts 1 is prepared. In the carbon paper, the large-diameter carbon fiber parts 1 are coupled to each other to thereby form a three-dimensional mesh structure, and thus the voids 10G are present.

Thereafter, the silicon-containing material is deposited onto the surface of each of the large-diameter carbon fiber parts 1 by means of a vapor-phase method. The vapor-phase method is not particularly limited in kind, and specifically, one or more kinds of vapor-phase methods including, without limitation, a vacuum deposition method, a chemical vapor deposition (CVD) method, and a sputtering method, are usable. The covering part 3 is thereby formed on the surface of each of the large-diameter carbon fiber parts 1. Thus, the surface of each of the large-diameter carbon fiber parts 1 is covered by the covering part 3. In this case, the average thickness AT1 of multiple covering parts 3 is controllable by adjusting the amount of deposition of the silicon-containing material.

The formation of the covering parts 3 causes some or all of the voids 10G to become smaller in inner diameter, thus causing the void rate R to become lower than the void rate R (what is called an initial void rate R) before the formation of the covering parts 3. By setting the initial void rate R to be sufficiently high, however, some or all of the voids 10G are prevented from being lost and thus remain even if the covering parts 3 are formed. The void rate R is therefore calculable even after the formation of the covering parts 3. In other words, the void rate R is controllable by adjusting the amount of deposition of the silicon-containing material.

Note that as the method of forming the covering parts 3, a liquid-phase method may be used instead of the vapor-phase method. The liquid-phase method is not particularly limited in kind. Specifically, a solution including, for example, polydihydrosilane that allows for formation of metal silicon is applied on the surfaces of the large-diameter carbon fiber parts 1 to thereby cause the solution to permeate into the large-diameter carbon fiber parts 1. Note that the large-diameter carbon fiber parts 1 may be immersed in the solution including, for example, polydihydrosilane to thereby cause the solution to permeate into the large-diameter carbon fiber parts 1. When using a carbon paper as the large-diameter carbon fiber parts 1, the above-described solution is caused to permeate into the carbon paper.

Thereafter, the small-diameter carbon fiber parts 2 are put into a solvent. The small-diameter carbon fiber parts 2 are thus dispersed in the solvent to result in a dispersion liquid. The solvent may be an aqueous solvent or a nonaqueous solvent (an organic solvent). In this case, a binder may be added to the solvent. Details of the binder are as described above.

Thereafter, the dispersion liquid is applied on the large-diameter carbon fiber parts 1 with the covering parts 3 formed thereon, following which the applied dispersion liquid is dried. The dispersion liquid including the small-diameter carbon fiber parts 2 thus permeates into the large-diameter carbon fiber parts 1, causing the small-diameter carbon fiber parts 2 to be fixed onto the surfaces of the covering parts 3. As a result, the small-diameter carbon fiber parts 2 are coupled to the surfaces of the covering parts 3, and the negative electrode 10 is thus fabricated. Note that the large-diameter carbon fiber parts 1 with the covering parts 3 formed thereon may be immersed in the dispersion liquid.

When causing the small-diameter carbon fiber parts 2 to be coupled to the surfaces of the covering parts 3, the small-diameter carbon fiber parts 2 may be directly formed on the surfaces of the covering parts 3 instead of indirectly forming the small-diameter carbon fiber parts 2 on the surfaces of the covering parts 3 using the dispersion liquid. In such a case, a metal catalyst is disposed on the surface of each of the covering parts 3, following which the small-diameter carbon fiber parts 2 are grown by means of CVD. The small-diameter carbon fiber parts 2 are each thereby firmly coupled to the surface of any of the covering parts 3, which allows for formation of a firm electrically conductive network.

Lastly, on an as-needed basis, the negative electrode 10 is pressed by means of, for example, a pressing machine, following which the negative electrode 10 is subjected to firing. In this case, the void rate R is controllable by adjusting pressure applied in pressing. A firing temperature may be set as desired.

The negative electrode 10 including the large-diameter carbon fiber parts 1, the small-diameter carbon fiber parts 2, and the covering parts 3, and having the voids 10G is thus completed. When fabricating the negative electrode 10, the weight proportion M is controllable by adjusting, for example, the amount of deposition of the silicon-containing material and a concentration of the small-diameter carbon fiber parts 2 in the dispersion liquid.

Note that when fabricating the negative electrode 10, after obtaining the large-diameter carbon fiber parts 1 with the covering parts 3 formed thereon by the above-described procedure, a paper manufacturing process may be employed using the large-diameter carbon fiber parts 1 with the covering parts 3 formed thereon and the small-diameter carbon fiber parts 2. In this case, a wet process such as papermaking or a dry process using, for example, a web may be employed. In this case also, the negative electrode 10 including the large-diameter carbon fiber parts 1, the small-diameter carbon fiber parts 2, and the covering parts 3, and having the voids 10G is fabricated.

The negative electrode 10 includes the large-diameter carbon fiber parts 1, the small-diameter carbon fiber parts 2, and the covering parts 3, and has the voids 10G. The large-diameter carbon fiber parts 1 and the small-diameter carbon fiber parts 2 each include the carbon-containing material. The covering parts 3 each include the silicon-containing material. Regarding the average fiber diameters AD1 and AD2 and the void rate R, the above-described conditions (AD1: 10 nm to 8000 nm; AD2: 1 nm to 300 nm; and the void rate R: 40 vol % to 70 vol %) are satisfied.

In this case, as described above, the average fiber diameters AD1 and AD2 and the void rate R are each made appropriate. Accordingly, a series of actions described below is achieved.

Firstly, in the negative electrode 10, an electrically conductive network (a three-dimensional mesh structure) is formed by the large-diameter carbon fiber parts 1 that include the carbon-containing material having electrical conductivity, and in addition, a dense electrically conductive network is formed by the small-diameter carbon fiber parts 2 that similarly include the carbon-containing material having electrical conductivity.

Secondly, the covering parts 3 each include the silicon-containing material that is

superior in electrode-reactant insertability and electrode-reactant extractability. Accordingly, a high energy density is obtainable.

Thirdly, even though the covering parts 3 each include the silicon-containing material, an internal stress occurring in the negative electrode 10 upon charging and discharging, that is, upon expansion and contraction of each of the covering parts 3, is mitigated by virtue of the voids 10G. This suppresses expansion and contraction of the negative electrode 10. As a result, degradation of the negative electrode 10 caused by the internal stress occurring upon the expansion and contraction of the covering parts 3 is suppressed. In this case, in particular, even if the silicon-containing material is high in silicon content, the expansion and contraction of the negative electrode 10 is sufficiently suppressed, and the degradation of the negative electrode 10 is effectively suppressed accordingly.

By virtue of the foregoing, the extraction and contraction of the negative electrode 10 is suppressed upon charging and discharging, and a discharge capacity is prevented from easily decreasing even upon repeated charging and discharging, while a high energy density is obtainable. Accordingly, it is possible for a secondary battery including the negative electrode 10 to achieve a superior initial capacity characteristic, a superior swelling characteristic, and a superior cyclability characteristic.

Note that because it is unnecessary to provide the metal current collector in the negative electrode 10 described above, it is possible for the negative electrode 10 to achieve a reduction in weight and an increase in gravimetric energy density (Wh/kg), as compared with when the negative electrode 10 includes the metal current collector.

In particular, the weight proportion M may be in the range from 40 wt % to 76 wt % both inclusive. In such a case, an appropriate relation is achievable between the weight of the carbon component (the large-diameter carbon fiber parts 1 and the small-diameter carbon fiber parts 2) and the weight of the silicon component (the covering parts 3) in the negative electrode 10. Accordingly, a sufficient energy density is obtainable while the electrical conductivity is ensured. It is thus possible to achieve higher effects. Further, the average thickness AT1 of the covering parts 3 may be in the range from 2.8 nm to 1300 nm both inclusive. In such a case, the covering parts 3 are each formed in a sufficiently large amount, while electron conductivity between the large-diameter carbon fiber parts 1 is ensured. Accordingly, a sufficient energy density is obtainable while the electrical conductivity is ensured. It is thus possible to achieve higher effects.

Further, the content of silicon in each of the covering parts 3 (the silicon-containing material) may be greater than or equal to 80 wt %. In such a case, a markedly high energy density is obtainable while the electrical conductivity is ensured. Accordingly, it is possible to achieve higher effects.

Further, some or all of the small-diameter carbon fiber parts 2 may each be coupled to two or more of the covering parts 3. In such a case, the two or more of the covering parts 3 are electrically coupled to each other via one or more of the small-diameter carbon fiber parts 2. This results in a denser electrically conductive network, and thus makes it possible to achieve higher effects.

Here, when the void rate R has the large value described above (i.e., 40 vol % to 70 vol %), the electrically conductive network tends to be sparse. In addition, decoupling of the electrically conductive network easily occurs because the covering parts 3 including the silicon-containing material expand and contract upon an electrode reaction. However, if some or all of the small-diameter carbon fiber parts 2 are each coupled to two or more of the covering parts 3 as described above, a dense electrically conductive network is easily formed, and the electrically conductive network is prevented from being decoupled easily.

Further, the large-diameter carbon fiber parts 1 may include a carbon paper. This allows the large-diameter carbon fiber parts 1 to be sufficiently coupled to each other and allows the average fiber diameter AD1 to be sufficiently large. As a result, a sufficient electrically conductive network (three-dimensional mesh structure) is formed. It is thus possible to achieve higher effects.

Further, the small-diameter carbon fiber parts 2 may include a single-walled carbon nanotube, a vapor-grown carbon fiber, or both. This allows the average fiber diameter AD2 to be sufficiently small. Accordingly, the small-diameter carbon fiber parts 2 are sufficiently dispersed in the negative electrode 10 easily and a denser electrically conductive network is formed easily.

It is thus possible to achieve higher effects.

Next, a description is given of a secondary battery according to an embodiment of the technology and, more specifically, an example secondary battery that includes the negative electrode 10 described above.

As described above, the secondary battery to be described here is a secondary battery that obtains a battery capacity using insertion and extraction of an electrode reactant, and includes a positive electrode, a negative electrode, a separator, and an electrolytic solution, i.e., a liquid electrolyte. The electrode reactant is not particularly limited in kind, as described above.

Examples are given below of a case where the electrode reactant is lithium. A secondary battery that obtains a battery capacity using insertion and extraction of lithium is what is called a lithium-ion secondary battery. In the lithium-ion secondary battery, lithium is inserted and extracted in an ionic state.

In this case, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

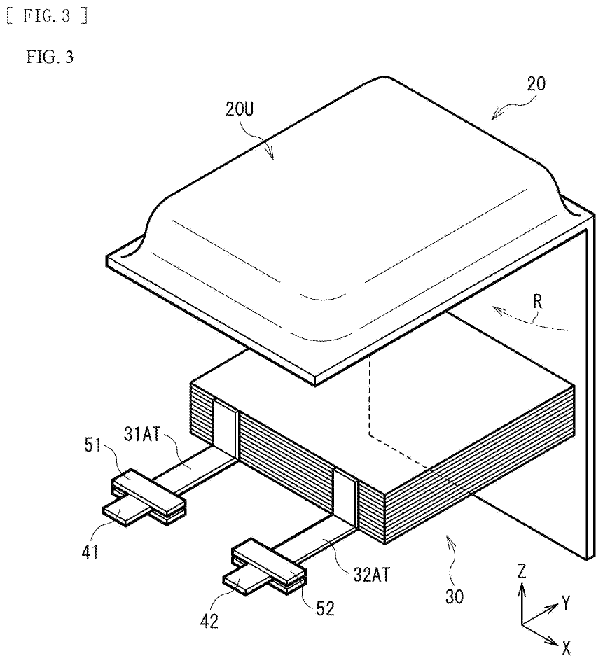

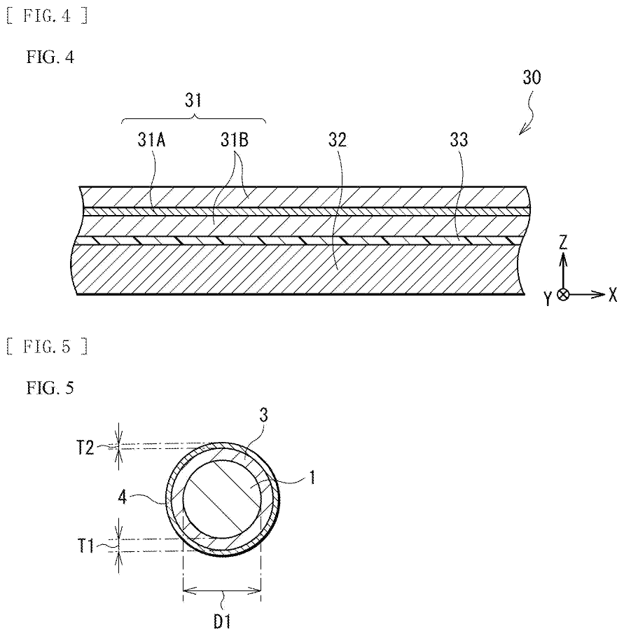

FIG. 3 illustrates a perspective configuration of the secondary battery. FIG. 4 illustrates an enlarged sectional configuration of a battery device 30 illustrated in FIG. 3. Note that FIG. 3 illustrates a state in which an outer package film 20 and the battery device 30 are separated from each other, and FIG. 4 illustrates only a portion of the battery device 30. In the following description, reference will be made as necessary to FIGS. 1 and 2 described already above, and also to the components of the negative electrode 10 described already above.

As illustrated in FIGS. 3 and 4, the secondary battery includes the outer package film 20, the battery device 30, a positive electrode lead 41, a negative electrode lead 42, and sealing films 51 and 52. The secondary battery described here is a secondary battery of a laminated-film type in which the outer package film 20 having flexibility or softness is used.

As illustrated in FIG. 3, the outer package film 20 is a flexible outer package member that contains the battery device 30. The outer package film 20 has a pouch-shaped structure that is sealed in a state where the battery device 30 is contained inside the outer package film 20. The outer package film 20 thus contains a positive electrode 31, a negative electrode 32, and an electrolytic solution that are to be described later.

Here, the outer package film 20 is a single film-shaped member, and is folded in a folding direction F. The outer package film 20 has a depression part 20U to place the battery device 30 therein. The depression part 20U is what is called a deep drawn part.

Specifically, the outer package film 20 is a three-layered laminated film including a fusion-bonding layer, a metal layer, and a surface protective layer that are stacked in this order from an inner side. In a state where the outer package film 20 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 20 is not particularly limited in configuration or the number of layers, and may be single-layered or two-layered, or may include four or more layers.

As illustrated in FIGS. 3 and 4, the battery device 30 is a power generation device that includes the positive electrode 31, the negative electrode 32, a separator 33, and the electrolytic solution (not illustrated). The battery device 30 is contained inside the outer package film 20.

The battery device 30 is what is called a stacked electrode body. The positive electrode 31 and the negative electrode 32 are thus stacked on each other with the separator 33 interposed therebetween. The respective numbers of the positive electrodes 31, the negative electrodes 32, and the separators 33 to be stacked are not particularly limited. Here, multiple positive electrodes 31 and multiple negative electrodes 32 are alternately stacked with the separators 33 each interposed between corresponding one of the positive electrodes 31 and corresponding one of the negative electrodes 32.

As illustrated in FIG. 4, the positive electrode 31 includes a positive electrode current collector 31A and a positive electrode active material layer 31B.

The positive electrode current collector 31A has two opposed surfaces on each of which the positive electrode active material layer 31B is to be provided. The positive electrode current collector 31A includes an electrically conductive material such as a metal material. Specific examples of the metal material include aluminum.

Note that as illustrated in FIG. 3, the positive electrode current collector 31A includes a protruding part 31AT without the positive electrode active material layer 31B provided thereon. Multiple protruding parts 31AT are joined to each other into a single lead form. Here, the protruding part 31AT is integrated with a portion of the positive electrode current collector 31A other than the protruding part 31AT. However, the protruding part 31AT may be provided separately from the portion of the positive electrode current collector 31A other than the protruding part 31AT, and may thus be joined to the portion of the positive electrode current collector 31A other than the protruding part 31AT.

The positive electrode active material layer 31B includes any one or more of positive electrode active materials into which lithium is insertable and from which lithium is extractable. Note that the positive electrode active material layer 31B may further include any one or more of other materials including, without limitation, a positive electrode binder and a positive electrode conductor.

Here, the positive electrode active material layer 31B is provided on each of the two opposed surfaces of the positive electrode current collector 31A. Note that the positive electrode active material layer 31B may be provided only on one of the two opposed surfaces of the positive electrode current collector 31A on a side where the positive electrode 31 is opposed to the negative electrode 32. A method of forming the positive electrode active material layer 31B is not particularly limited, and specifically, one or more of methods including, without limitation, a coating method, are usable.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are any of elements other than lithium and the transition metal elements, and are not particularly limited in kind. Specifically, the one or more other elements are any of elements belonging to groups 2 to 15 in the long period periodic table. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes one or more of electrically conductive materials including, without limitation, a carbon material. Specific examples of the carbon material include graphite, carbon black, acetylene black, Ketjen black, and a carbon nanotube. Note that the electrically conductive material may be a metal material or a polymer compound, for example.

As illustrated in FIG. 4, the negative electrode 32 is opposed to the positive electrode 31 with the separator 33 interposed therebetween. Lithium is insertable to and extractable from the negative electrode 32. The negative electrode 32 has a configuration similar to the configuration of the negative electrode 10 described above, and thus includes the large-diameter carbon fiber parts 1, the small-diameter carbon fiber parts 2, and the covering parts 3. In the negative electrode 32, lithium is inserted to and extracted from each of the covering parts 3 mainly. However, lithium may be inserted to and extracted from the large-diameter carbon fiber parts 1, the small-diameter carbon fiber parts 2, or both, as well as each of the covering parts 3.

Note that as illustrated in FIG. 3, the negative electrode 32 includes a protruding part 31AT that includes some of the large-diameter carbon fiber parts 1 without the covering parts 3 provided thereon. Multiple protruding parts 31AT are joined to each other into a single lead form.

The separator 33 is an insulating porous film interposed between the positive electrode 31 and the negative electrode 32, as illustrated in FIG. 4. The separator 33 allows lithium ions to pass therethrough while preventing contact (a short circuit) between the positive electrode 31 and the negative electrode 32. The separator 33 includes a polymer compound such as polyethylene.

The electrolytic solution includes a solvent and an electrolyte salt. The positive electrode 31, the negative electrode 32, and the separator 33 are each impregnated with the electrolytic solution.

The solvent includes one or more of nonaqueous solvents (organic solvents) including, without limitation, a carbonic-acid-ester-based compound, a carboxylic-acid-ester-based compound, and a lactone-based compound. The electrolytic solution including the non-aqueous solvent(s) is what is called a nonaqueous electrolytic solution.

The carbonic-acid-ester-based compound is, for example, a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include methyl acetate, ethyl acetate, methyl trimethylacetate, methyl propionate, ethyl propionate, and propyl propionate.

The lactone-based compound is, for example, a lactone. Specific examples of the lactone include y-butyrolactone and y-valerolactone.

The electrolyte salt includes one or more of light metal salts including, without limitation, a lithium salt.

Specific examples of the lithium salt include lithium hexafluorophosphate (LiPF₆), lithium tetrafluoroborate (LiBF₄), lithium bis(fluorosulfonyl)imide (LiN(FSO₂)₂), lithium bis(trifluoromethanesulfonyl)imide (LiN(CF₃SO₂)₂), lithium bis(oxalato)borate (LiB(C₂O₄)₂), lithium difluoro(oxalato)borate (LiB(C₂O₄)F₂), lithium monofluorophosphate (Li₂PFO₃), and lithium difluorophosphate (LiPF₂O₂).

Although not particularly limited, a content of the electrolyte salt is specifically in a range from 0.3 mol/kg to 3.0 mol/kg both inclusive with respect to the solvent. A reason for this is that high ion conductivity is obtainable.

Note that the electrolytic solution may further include one or more of additives. The additives are not particularly limited in kind, and specific examples thereof include an unsaturated cyclic carbonic acid ester, a halogenated carbonic acid ester, a phosphoric acid ester, an acid anhydride, a nitrile compound, and an isocyanate compound.

Specific examples of the unsaturated cyclic carbonic acid ester include vinylene carbonate, vinylethylene carbonate, and methylene ethylene carbonate. Specific examples of the halogenated carbonic acid ester include a halogenated cyclic carbonic acid ester and a halogenated chain carbonic acid ester. Specific examples of the halogenated cyclic carbonic acid ester include monofluoroethylene carbonate and difluoroethylene carbonate. Specific examples of the halogenated chain carbonic acid ester include fluoromethyl methyl carbonate. Specific examples of the phosphoric acid ester include trimethyl phosphate and triethyl phosphate.

The acid anhydride is a dicarboxylic acid anhydride, a disulfonic acid anhydride, or a carboxylic acid sulfonic acid anhydride, for example. Specific examples of the dicarboxylic acid anhydride include succinic anhydride. Specific examples of the disulfonic acid anhydride include ethanedisulfonic anhydride. Specific examples of the carboxylic acid sulfonic acid anhydride include sulfobenzoic anhydride.

The nitrile compound is a mononitrile compound, a dinitrile compound, or a trinitrile compound, for example. Specific examples of the mononitrile compound include acetonitrile. Specific examples of the dinitrile compound include succinonitrile. Specific examples of the trinitrile compound include 1,2,3-propanetricarbonitrile. Specific examples of the isocyanate compound include hexamethylene diisocyanate.

As illustrated in FIG. 3, the positive electrode lead 41 is a positive electrode terminal coupled to a joined body of the protruding parts 31AT of the positive electrodes 31, and is led from an inside to an outside of the outer package film 20. The positive electrode lead 41 includes an electrically conductive material such as a metal material. Specific examples of the metal material include aluminum. The positive electrode lead 41 is not particularly limited in shape, and specifically has any of shapes including, without limitation, a thin plate shape and a meshed shape.

As illustrated in FIG. 3, the negative electrode lead 42 is a negative electrode terminal coupled to a joined body of the protruding parts 32AT of the negative electrodes 32, and is led from the inside to the outside of the outer package film 20. The negative electrode lead 42 is preferably coupled to the large-diameter carbon fiber parts 1 of the negative electrode 32, in particular. A reason for this is that in such a case, an improved electrical continuity characteristic is achievable between the negative electrode 32 and the negative electrode lead 42. The negative electrode lead 42 includes an electrically conductive material such as a metal material. Specific examples of the metal material include copper. Here, the negative electrode lead 42 is led out in a direction similar to that in which the positive electrode lead 41 is led out. Details of a shape of the negative electrode lead 42 are similar to the details of the shape of the positive electrode lead 41.

The sealing film 51 is interposed between the outer package film 20 and the positive electrode lead 41. The sealing film 52 is interposed between the outer package film 20 and the negative electrode lead 42. Note that the sealing film 51, the sealing film 52, or both may be omitted.

The sealing film 51 is a sealing member that prevents entry of, for example, outside air into the outer package film 20. Further, the sealing film 51 includes a polymer compound, such as a polyolefin, that has adherence to the positive electrode lead 41. Examples of the polyolefin include polypropylene.

The sealing film 52 has a configuration similar to the configuration of the sealing film 51 except that the sealing film 52 is a sealing member that has adherence to the negative electrode lead 42. That is, the sealing film 52 includes a polymer compound, such as a polyolefin, that has adherence to the negative electrode lead 42.

Upon charging the secondary battery, in the battery device 30, lithium is extracted from the positive electrode 31, and the extracted lithium is inserted into the negative electrode 32 via the electrolytic solution. Upon discharging the secondary battery, in the battery device 30, lithium is extracted from the negative electrode 32, and the extracted lithium is inserted into the positive electrode 31 via the electrolytic solution. Upon charging and discharging, lithium is inserted and extracted in an ionic state.

When manufacturing the secondary battery, the positive electrode 31 and the negative electrode 32 are each fabricated and the electrolytic solution is prepared, following which the secondary battery is assembled and the assembled secondary battery is subjected to a stabilization process, in accordance with an example procedure described below.

First, a mixture in which the positive electrode active material, the positive electrode

binder, and the positive electrode conductor are mixed with each other, i.e., a positive electrode mixture, is put into a solvent to thereby prepare a positive electrode mixture slurry in a paste form. The solvent may be an aqueous solvent, or may be an organic solvent. Thereafter, the positive electrode mixture slurry is applied on the two opposed surfaces (excluding the protruding part 31AT) of the positive electrode current collector 31A including the protruding part 31AT to thereby form the positive electrode active material layers 31B. Lastly, the positive electrode active material layers 31B are compression-molded by means of, for example, a roll pressing machine. In this case, the positive electrode active material layers 31B may be heated. The positive electrode active material layers 31B may be compression-molded multiple times. In this manner, the positive electrode active material layers 31B are formed on the respective two opposed surfaces of the positive electrode current collector 31A. The positive electrode 31 is thus fabricated.

The negative electrode 32 including the protruding part 32AT is fabricated by a procedure similar to the fabrication procedure of the negative electrode 10 described above.

The electrolyte salt is put into the solvent. The electrolyte salt is thereby dispersed or dissolved in the solvent. The electrolytic solution is thus prepared.

First, the positive electrodes 31 and the negative electrodes 32 are alternately stacked with the separators 33 each interposed between corresponding one of the positive electrodes 31 and corresponding one of the negative electrodes 32 to thereby fabricate an unillustrated stacked body. The stacked body has a configuration similar to the configuration of the battery device 30 except that the positive electrodes 31, the negative electrodes 32, and the separators 33 are each unimpregnated with the electrolytic solution.

Thereafter, the protruding parts 31AT are joined to each other, and the protruding parts 32AT are joined to each other. Thereafter, the positive electrode lead 41 is joined to the joined body of the protruding parts 31AT, and the negative electrode lead 42 is coupled to the joined body of the protruding parts 32AT.

Thereafter, the stacked body is placed in the depression part 20U, following which the outer package film 20 (the fusion-bonding layer/the metal layer/the surface protective layer) is folded to thereby cause parts of the outer package film 20 to be opposed to each other. Thereafter, outer edge parts of two sides of the outer package film 20 (the fusion-bonding layer) opposed to each other are bonded to each other by a method such as a thermal-fusion-bonding method. The stacked body is thus contained inside the outer package film 20 having a pouch shape.

Lastly, the electrolytic solution is injected into the outer package film 20 having the pouch shape, following which the outer edge parts of the remaining one side of the outer package film 20 (the fusion-bonding layer) are bonded to each other by a method such as a thermal-fusion-bonding method. In this case, the sealing film 51 is interposed between the outer package film 20 and the positive electrode lead 41, and the sealing film 52 is interposed between the outer package film 20 and the negative electrode lead 42.

The stacked body is thereby impregnated with the electrolytic solution. Thus, the battery device 30, i.e., the stacked electrode body, is fabricated. In this manner, the battery device 30 is sealed in the outer package film 20 having the pouch shape, and the secondary battery is thus assembled.

The assembled secondary battery is charged and discharged. Various conditions including, without limitation, an environment temperature, the number of times of charging and discharging (the number of cycles), and charging and discharging conditions may be set as desired. A film is thereby formed on a surface of each of the positive electrode 31 and the negative electrode 32. This brings the secondary battery into an electrochemically stable state. The secondary battery is thus completed.

According to the secondary battery, the negative electrode 32 has the configuration similar to the configuration of the negative electrode 10 described above. Accordingly, for a reason similar to that described in relation to the negative electrode 10, it is possible to achieve a superior initial capacity characteristic, a superior swelling characteristic, and a superior cyclability characteristic.

The secondary battery may include a lithium-ion secondary battery. In such a case, a sufficient battery capacity is obtainable stably by using insertion and extraction of lithium. Accordingly, it is possible to achieve higher effects.

Other action and effects related to the secondary battery are similar to those related to the negative electrode 10 described above.

Next, a description is given of modifications according to an embodiment.

The configuration of each of the negative electrode 10 and the secondary battery described above is appropriately modifiable as described below. Note that any two or more of the following series of modifications may be combined with each other.

As illustrated in FIG. 5 corresponding to FIG. 2, the negative electrode 10 may further include multiple surface parts 4. In FIG. 5, unlike in FIG. 2, only the surface part 4 is illustrated together with the large-diameter carbon fiber part 1 and the covering part 3.

The surface parts 4 are each provided on the surface of corresponding one of the covering parts 3, and each have a thickness T2. Further, the surface parts 4 each include any one or more of ion conductive materials. A reason for this is that this improves the negative electrode 10 in ion conductivity. The ion conductive materials are not particularly limited in kind.

Specifically, the ion conductive material is a solid electrolyte such as lithium phosphorous oxynitride or lithium phosphate (Li₃PO₄). The lithium phosphorous oxynitride is not particularly limited in composition, and specific examples of the composition thereof include Li_{3.30}PO_{3.90}N_{0.17}.

Alternatively, the ion conductive material is a gel electrolyte in which an electrolytic solution is held by a matrix polymer compound. The electrolytic solution has a configuration as described above. Specific examples of the matrix polymer compound include polyethylene oxide and polyvinylidene difluoride.

In particular, the ion conductive material preferably includes the solid electrolyte. That is, the ion conductive material preferably includes lithium phosphorous oxynitride, lithium phosphate, or both. A reason for this is that in such a case, the ion conductivity of the negative electrode 10 sufficiently improves.

Note that the surface part 4 may be provided entirely on the surface of the covering part 3, or may be provided partially on the surface of the covering part 3. In the latter case, multiple surface parts 4 separate from each other may be provided on the surface of the covering part 3.

An average thickness AT2 of the surface parts 4 is not particularly limited, and may be set as desired. A procedure to calculate the average thickness AT2 is similar to the procedure to calculate the average thickness AT1 described above, except that the thicknesses T2 of the surface parts 4 are measured instead of the thicknesses T1 of the covering parts 3.

A procedure to form the surface parts 4 is as described below. When using the solid electrolyte as the ion conductive material, the surface parts 4 are directly formed on the surfaces of the covering parts 3 by means of a vapor-phase method such as a sputtering method. When using the gel electrolyte as the ion conductive material, a solution including the electrolytic solution, the matrix polymer compound, and a solvent for dilution is applied on the surfaces of the covering parts 3, following which the applied solution is dried. Details of the kind of the solvent are as described above. Note that after the small-sized carbon fiber parts 2 are coupled to the surfaces of the covering parts 3, the covering parts 3 and other components may be immersed in the solution.

In this case, the surface parts 4 help to improve the ion conductivity for lithium ions in the negative electrode 10. Accordingly, it is possible to achieve higher effects.

In particular, the use of the surface parts 4 including the ion conductive material allows for application of the negative electrode 10 to an all-solid-state battery. A reason for this is that the expansion and contraction of the negative electrode 10 is suppressed and accordingly, an increase in resistance at an interface between the negative electrode 10 and the solid electrolyte is suppressed. As a result, it is possible for the all-solid-state battery to achieve both ensured safety and improved energy density.

The separator 33 that is a porous film is used. However, although not specifically illustrated here, a separator of a stacked type including a polymer compound layer may be used instead of the separator 33.

Specifically, the separator of the stacked type includes a porous film having two opposed surfaces, and a polymer compound layer disposed on one of or each of the two opposed surfaces of the porous film. A reason for this is that in such a case, adherence of the separator to each of the positive electrode 31 and the negative electrode 32 improves to suppress the occurrence of winding displacement of the battery device 30. This helps to prevent the secondary battery from swelling easily even if a decomposition reaction of the electrolytic solution occurs. The porous film has a configuration similar to the configuration of the porous film described in relation to the separator 33. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may include one or more kinds of insulating particles. A reason for this is that the insulating particles facilitate dissipation of heat upon heat generation by the secondary battery, thus improving safety or heat resistance of the secondary battery. The insulating particles include inorganic particles, resin particles, or both. Specific examples of the inorganic particles include particles of materials including, without limitation, aluminum oxide, aluminum nitride, boehmite, silicon oxide, titanium oxide, magnesium oxide, and zirconium oxide. Specific examples of the resin particles include particles of materials including, without limitation, acrylic resin and styrene resin.

When fabricating the separator of the stacked type, a precursor solution including, without limitation, the polymer compound and a solvent is prepared and thereafter, the precursor solution is applied on one of or each of the two opposed surfaces of the porous film. In this case, the porous film may be immersed in the precursor solution instead of applying the precursor solution on the surface(s) of the porous film. Note that the insulating particles may be added to the precursor solution.

When the separator of the stacked type is used also, lithium ions are movable between the positive electrode 31 and the negative electrode 32, and similar effects are therefore obtainable. In this case, in particular, the secondary battery improves in safety, as described above. Accordingly, it is possible to achieve higher effects.

The electrolytic solution, i.e., a liquid electrolyte, is used. However, although not specifically illustrated here, an electrolyte layer that is a gel electrolyte may be used instead of the electrolytic solution.

In the battery device 30 including the electrolyte layer, the positive electrode 31 and the negative electrode 32 are alternately stacked with the separator 33 and the electrolyte layer interposed therebetween. In this case, the electrolyte layer is interposed between the positive electrode 31 and the separator 33, and between the negative electrode 32 and the separator 33. Note that the electrolyte layer may be interposed only between the positive electrode 31 and the separator 33, or may be interposed only between the negative electrode 32 and the separator 33.

Specifically, the electrolyte layer includes a polymer compound together with the electrolytic solution. The electrolytic solution is held by the polymer compound. A reason for this is that this prevents leakage of the electrolytic solution. The configuration of the electrolytic solution is as described above. The polymer compound includes, for example, polyvinylidene difluoride. When forming the electrolyte layer, a precursor solution including, without limitation, the electrolytic solution, the polymer compound, and a solvent for dilution is prepared and thereafter, the precursor solution is applied on one side or both sides of the positive electrode 31 and on one side or both sides of the negative electrode 32. Details of the kind of the solvent are as described above.

When the electrolyte layer is used also, lithium ions are movable between the positive electrode 31 and the negative electrode 32 via the electrolyte layer, and similar effects are therefore obtainable. In this case, in particular, leakage of the electrolytic solution is prevented, as described above. Accordingly, it is possible to achieve higher effects.

Lastly, a description is given of applications (application examples) of the secondary battery.

The applications of the secondary battery are not particularly limited. The secondary battery used as a power source may serve as a main power source or an auxiliary power source of, for example, electronic equipment or an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles.

Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

One of application examples of the secondary battery will now be described in detail. The configuration described below is merely an example, and is appropriately modifiable.

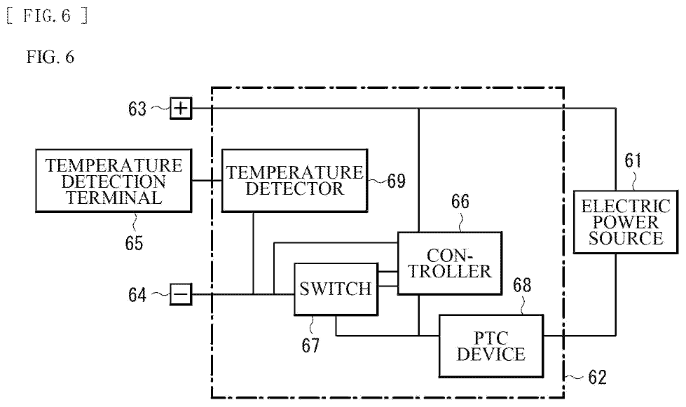

FIG. 6 illustrates a block configuration of a battery pack. The battery pack described here is a battery pack (what is a called a soft pack) including one secondary battery, and is to be mounted on, for example, electronic equipment typified by a smartphone.

As illustrated in FIG. 6, the battery pack includes an electric power source 61 and a circuit board 62. The circuit board 62 is coupled to the electric power source 61, and includes a positive electrode terminal 63, a negative electrode terminal 64, and a temperature detection terminal 65.

The electric power source 61 includes one secondary battery. The secondary battery has a positive electrode lead coupled to the positive electrode terminal 63 and a negative electrode lead coupled to the negative electrode terminal 64. The electric power source 61 is couplable to outside via the positive electrode terminal 63 and the negative electrode terminal 64, and is thus chargeable and dischargeable. The circuit board 62 includes a controller 66, a switch 67, a thermosensitive resistive (PTC) device 68, and a temperature detector 69. However, the PTC device 68 may be omitted.

The controller 66 includes, for example, a central processing unit (CPU) and a memory, and controls an overall operation of the battery pack. The controller 66 detects and controls a use state of the electric power source 61 on an as-needed basis.

If a voltage of the electric power source 61 (the secondary battery) reaches an

overcharge detection voltage or an overdischarge detection voltage, the controller 66 turns off the switch 67. This prevents a charging current from flowing into a current path of the electric power source 61. The overcharge detection voltage is not particularly limited, and is specifically 4.2 V±0.05 V. The overdischarge detection voltage is not particularly limited, and is specifically 2.4 V±0.1 V.

The switch 67 includes, for example, a charge control switch, a discharge control switch, a charging diode, and a discharging diode. The switch 67 performs switching between coupling and decoupling between the electric power source 61 and external equipment in accordance with an instruction from the controller 66. The switch 67 includes, for example, a metal-oxide-semiconductor field-effect transistor (MOSFET). The charging and discharging currents are detected based on an ON-resistance of the switch 67.

The temperature detector 69 includes a temperature detection device such as a thermistor. The temperature detector 69 measures a temperature of the electric power source 61 using the temperature detection terminal 65, and outputs a result of the temperature measurement to the controller 66. The result of the temperature measurement to be obtained by the temperature detector 69 is used, for example, when the controller 66 performs charge and discharge control upon abnormal heat generation or when the controller 66 performs a correction process upon calculating a remaining capacity.

### EXAMPLES

A description is given of Examples of the present technology according to an embodiment.

### Examples 1 to 14 and Comparative Examples 1 to 7

Secondary batteries were fabricated, following which the secondary batteries were evaluated for their characteristics. Here, two kinds of secondary batteries (a first secondary battery and a second secondary battery) were fabricated to evaluate the characteristics of the secondary batteries.

### [Fabrication of First Secondary Battery]

The first secondary battery (Examples 1 to 14 and Comparative examples 4 to 7) was fabricated in accordance with the following procedure. The first secondary battery was a lithium-ion secondary battery of the laminated film type (having a battery capacity of 7 mAh to 12 mAh) illustrated in FIGS. 3 and 4.

In the following description, to describe the process of fabricating the negative electrode 32, reference will be made as necessary to the components of the negative electrode 10 illustrated in FIGS. 1 and 2.

### (Fabrication of Positive Electrode)

First, 97 parts by mass of the positive electrode active material (LiNi_{0.8}Co_{0.15}Al_{0.05}O₂), 2.2 parts by mass of the positive electrode binder (polyvinylidene difluoride), and 0.8 parts by mass of the positive electrode conductor (Ketjen black) were mixed with each other to thereby obtain a positive electrode mixture. Thereafter, the positive electrode mixture was put into a solvent (N-methyl-2-pyrrolidone, i.e., an organic solvent), following which the solvent was stirred by means of a planetary centrifugal mixer to thereby prepare a positive electrode mixture slurry in a paste form. Thereafter, by means of a coating apparatus, the positive electrode mixture slurry was applied on the two opposed surfaces (excluding the protruding part 31AT) of the positive electrode current collector 31A (an aluminum foil having a thickness of 15 μm) including the protruding part 31AT, following which the applied positive electrode mixture slurry was dried (at a drying temperature of 120° C.) to thereby form the positive electrode active material layers 31B. Lastly, the positive electrode active material layers 31B were compression-molded by means of a hand press machine (to cause the positive electrode active material layers 31B to be 3.5 g/cm³ in volume density). In this manner, the positive electrode 31 including the protruding part 31AT was fabricated.

### (Fabrication of Negative Electrode)

First, a carbon paper (CP, having a thickness of 50 μm) including the large-diameter carbon fiber parts 1 that included the protruding part 32AT was prepared. The carbon paper had a three-dimensional mesh structure formed by the large-diameter carbon fiber parts 1 and thus had the voids 10G. The voids 10G had their respective inner diameters greater than those after completion of the negative electrode 32. Note that the average fiber diameter AD1 (nm) of the large-diameter carbon fiber parts 1 was as listed in Tables 1 and 2.

Thereafter, the covering parts 3 were formed by depositing the silicon-containing material (a simple substance of silicon (Si)) on the respective surfaces (excluding the protruding part 32AT) of the large-diameter carbon fiber parts 1 by means of a vacuum deposition method. In this case, silicon (having a purity of 99.9%) was used as a deposition source. Two deposition sources were thus so disposed as to allow the large-diameter carbon fiber parts 1 to be interposed therebetween, a deposition rate was set to 90 nm/min, and a weight per unit area of the silicon-containing material was set to 2.0 mg/cm². Note that the average thickness AT1 (nm) of the covering parts 3 was as listed in Tables 1 and 2.

Thereafter, 16 parts by mass of the small-diameter carbon fiber parts 2 (a single-walled carbon nanotube (SWCNT) or a vapor-grown carbon fiber (VGCF)) and 84 parts by mass of a binder (polyvinylidene difluoride) were put into a solvent (N-methyl-2-pyrrolidone, i.e., an organic solvent), following which the solvent was stirred to thereby prepare a dispersion liquid. Note that the average fiber diameter AD2 (nm) of the small-diameter carbon fiber parts 2 was as listed in Tables 1 and 2.

Thereafter, the dispersion liquid was applied on the large-diameter carbon fiber parts 1 (excluding the protrusion 32AT) with the covering parts 3 formed thereon. The dispersion liquid was thereby caused to permeate into the three-dimensional mesh structure formed by the large-diameter carbon fiber parts 1. As a result, the small-diameter carbon fiber parts 2 were fixed onto (coupled to) the surfaces of the covering parts 3. Thus, the negative electrode 32 including the protruding part 32AT was fabricated. In this case, the weight per unit area of the small-diameter carbon fiber parts 2 was set to 0.02 mg/cm² .

Lastly, the negative electrode 32 was pressed in an ambient temperature environment (at a temperature of 23° C.), following which the negative electrode 32 was heated (at a heating temperature of 350° C. for a heating time of 3 hours) in a nitrogen (N₂) atmosphere. In this case, the void rate R (vol %) was varied as listed in Tables 1 and 2 by adjusting the pressure applied in pressing.

The negative electrode 32 including the large-diameter carbon fiber parts 1, the small-diameter carbon fiber parts 2, and the covering parts 3 and having the voids 10G was thus completed. When fabricating the negative electrode 32, the weight proportion M (wt %) was varied as listed in Tables 1 and 2 by adjusting the amount of deposition of the silicon-containing material and the concentration of the small-diameter carbon fiber parts 2 in the dispersion liquid.

### (Preparation of Electrolytic Solution)

The electrolyte salt (lithium hexafluorophosphate) was added to the solvent, following which the solvent was stirred. Used as the solvent were ethylene carbonate as a cyclic carbonic acid ester, dimethyl carbonate as a chain carbonic acid ester, and monofluoroethylene carbonate as an additive (a halogenated cyclic carbonic acid ester). A mixture ratio (a weight ratio) between ethylene carbonate, dimethyl carbonate, and monofluoroethylene carbonate in the solvent was set to 30:60:10. The content of the electrolyte salt with respect to the solvent was set to 1 mol/kg. The electrolytic solution was thus prepared.

### [Assembly of First Secondary Battery]

First, the positive electrodes 31 including the protruding parts 31AT and the negative electrodes 32 including the protruding parts 32AT were stacked on each other with the separators 33 (fine porous polyethylene films each having a thickness of 20 μm) each interposed between corresponding one of the positive electrodes 31 and corresponding one of the negative electrodes 32 to thereby fabricate the stacked body (the positive electrode 31/the separator 33/the negative electrode 32).

Thereafter, the positive electrode lead 41 (an aluminum foil) was joined to the protruding parts 31AT, and the negative electrode lead 42 (a copper foil) was joined to the protruding parts 32AT.

Thereafter, the outer package film 20 (the fusion-bonding layer/the metal layer/the surface protective layer) was folded in such a manner as to sandwich the stacked body placed in the depression part 20U, following which the outer edge parts of two sides of the outer package film 20 (the fusion-bonding layer) were thermal-fusion-bonded to each other to thereby allow the stacked body to be contained inside the outer package film 20 having the pouch shape. As the outer package film 20, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from the inner side.

Lastly, the electrolytic solution was injected into the outer package film 20 having the pouch shape, following which the outer edge parts of the remaining one side of the outer package film 20 (the fusion-bonding layer) were thermal-fusion-bonded to each other in a reduced pressure environment. In this case, the sealing film 51 (a polypropylene film having a thickness of 5 μm) was interposed between the outer package film 20 and the positive electrode lead 41, and the sealing film 52 (a polypropylene film having a thickness of 5 μm) was interposed between the outer package film 20 and the negative electrode lead 42.

The stacked body was thereby impregnated with the electrolytic solution. Thus, the battery device 30 was fabricated. In this manner, the battery device 30 was sealed in the outer package film 20, and the first secondary battery was thus assembled.

When assembling the first secondary battery, a thickness of the positive electrode active material layer 31B was adjusted to set a capacity ratio, i.e., a ratio of a charge capacity of the positive electrode to the charge capacity of the negative electrode (=charge capacity of positive electrode/charge capacity of negative electrode), to 0.7.

### (Stabilization of First Secondary Battery)

The first secondary battery was charged and discharged for one cycle in an ambient temperature environment (at a temperature of 23° C.). Upon the charging, the first secondary battery was charged with a constant current of 0.1 C until a voltage reached 4.2 V, and was thereafter charged with a constant voltage of 4.2 V until a current reached 0.025 C. Upon the discharging, the first secondary battery was discharged with a constant current of 0.1 C until the voltage reached 2.0 V. Note that 0.1 C was a value of a current that caused a battery capacity (a theoretical capacity) to be completely discharged in 10 hours, and 0.025 C was a value of a current that caused the battery capacity to be completely discharged in 40 hours.

As a result, a film was formed on the surface of each of the positive electrode 31 and the negative electrode 32, which brought the first secondary battery into an electrochemically stable state. Thus, the first secondary battery was completed.

### [Fabrication of Second Secondary Battery]

The second secondary battery (having a battery capacity of 10 mAh to 15 mAh) was fabricated by a procedure similar to the fabrication procedure of the first secondary battery described above, except that a lithium metal plate (having a thickness of 100 μm) was used instead of the positive electrode 31.

Here, the first secondary battery including the positive electrode 31 as a counter electrode to the negative electrode 32 was what is called a full cell, whereas the second secondary battery including the lithium metal plate as the counter electrode to the negative electrode 32 was what is called a half cell.

### [Fabrication of Secondary Battery for Comparison]

Note that, for the purpose of comparisons, two kinds of secondary batteries for comparison (Comparative examples 1 and 2) were fabricated by a similar procedure except that a negative electrode for comparison was fabricated using a metal current collector.

When fabricating such a negative electrode, first, 82 parts by mass of a negative electrode active material (a simple substance of silicon (Si) having a purity of 95% and a median diameter D50 of 50 nm), 10 parts by mass (in terms of solids content) of a negative electrode binder (polyimide), 3 parts by mass of a negative electrode conductor (carbon black), and 5 parts by mass of another negative electrode conductor (a carbon nanotube dispersion) were mixed with each other to thereby obtain a negative electrode mixture. The carbon nanotube dispersion included 0.8 parts by mass of carbon nanotubes (the small-diameter carbon fiber parts 2) and 4.2 parts by mass of a dispersion medium (polyvinylidene difluoride).

Thereafter, the negative electrode mixture was put into a solvent (N-methyl-2-pyrrolidone, i.e., an organic solvent), following which the organic solvent was stirred by means of a planetary centrifugal mixer to thereby prepare a negative electrode mixture slurry in a paste form. Thereafter, by means of a coating apparatus, the negative electrode mixture slurry was applied on two opposed surfaces of a negative electrode current collector (a copper foil (Cu) having a thickness of 10 μm or 6μm), i.e., the metal current collector, following which the applied negative electrode mixture slurry was dried to thereby form negative electrode active material layers. The negative electrode was thereby fabricated.

Lastly, the negative electrode was pressed in an ambient temperature environment (at a temperature of 23° C.), following which the negative electrode was heated (at a heating temperature of 350° C. for a heating time of 3 hours) in a nitrogen atmosphere. In this case, the void rate R of the negative electrode active material layers was varied as listed in Tables 1 and 2 by adjusting the pressure applied in pressing.

Note that the “Metal current collector (thickness)” column in Tables 1 and 2 indicates the presence or absence of the metal current collector and, where the metal current collector was used, a material and a thickness (μm) thereof.

Further, for the purpose of comparisons, two kinds of secondary batteries for comparison (Comparative example 3) were fabricated by a similar procedure except that no small-diameter carbon fiber parts 2 were used.

### [Characteristic Evaluation of Secondary Battery]

Evaluation of the secondary batteries for their characteristics (their initial capacity characteristics, swelling characteristics, and cyclability characteristics) revealed the results presented in Tables 1 and 2.

In this case, by respective procedures described below, the initial capacity characteristic was evaluated using the second secondary battery (a half cell), and the swelling characteristic and the cyclability characteristic were each evaluated using the first secondary battery (a full cell).

### (Initial Capacity Characteristic)

The secondary battery was charged and discharged for one cycle in an ambient temperature environment (at a temperature of 23° C.) while applying pressure to the secondary battery to thereby measure the discharge capacity. An initial capacity as an index for evaluating the initial capacity characteristic was thus calculated in accordance with the following calculation expression: initial capacity (mAh/g)=discharge capacity (mAh)/total weight (g) of negative electrode 32.

In this case, the secondary battery was charged and discharged while causing the positive electrode 31 and the negative electrode 32 to be in close contact with each other with the separator 33 interposed therebetween, by applying pressure to the secondary battery in a direction in which the positive electrode 31 and the negative electrode 32 were stacked on each other with the separator 33 interposed therebetween. Note that the total weight of the negative electrode 32 described above included a weight of the metal current collector when the metal current collector was used, and did not include the weight of any metal current collector when no metal current collector was used.

Upon the charging, the secondary battery was charged with a constant current of 0.1 C until a voltage reached 0.005 V, and was thereafter charged with a constant voltage of 0.005 V until a current reached 0.01 C. Upon the discharging, the secondary battery was discharged with a constant current of 0.1 C until the voltage reached 1.5 V. Note that 0.01 C was a value of a current that caused the battery capacity to be completely discharged in 100 hours.

### (Swelling Characteristic)

First, a thickness (a pre-charging thickness) of the secondary battery was measured in an ambient temperature environment (at a temperature of 23° C.).

Thereafter, the secondary battery was charged while applying pressure to the secondary battery, following which the thickness (a post-charging thickness) of the secondary battery was measured.

In this case, as in the case of evaluating the initial capacity characteristic described above, the secondary battery was charged while causing the positive electrode 31 and the negative electrode 32 to be in close contact with each other with the separator 33 interposed therebetween, by applying pressure to the secondary battery. Upon the charging, the secondary battery was charged with a constant current of 0.1 C until a voltage reached 4.2 V, and was thereafter charged with a constant voltage of 4.2 V until a current reached 0.01 C.

Lastly, a swelling rate as an index for evaluating the swelling characteristic was calculated in accordance with the following calculation expression: swelling rate (%)=[(post-charging thickness−pre-charging thickness)/pre-charging thickness]×100.

### (Cyclability Characteristic)

First, the secondary battery was charged and discharged for one cycle in an ambient temperature environment (at a temperature of 23° C.) to thereby measure the discharge capacity (a first-cycle discharge capacity).

Upon the charging, the secondary battery was charged with a constant current of 0.5 C until a voltage reached 4.2 V, and was thereafter charged with a constant voltage of 4.2 V until a current reached 0.025 C. Upon the discharging, the secondary battery was discharged with a constant current of 0.5 C until the voltage reached 2.5 V. Note that 0.5 C was a value of a current that caused the battery capacity to be completely discharged in 2 hours.

Thereafter, the secondary battery was charged and discharged for 199 cycles in the same environment and under similar charging and discharging conditions to thereby measure the discharge capacity (a 200th-cycle discharge capacity).

Lastly, a capacity retention rate as an index for evaluating the cyclability characteristic was calculated in accordance with the following calculation expression: capacity retention rate (%)=(200th-cycle discharge capacity/first-cycle discharge capacity)×100.

### (Normalization of Characteristic Value)

Note that values of the initial capacity listed in each of Tables 1 and 2 are normalized values that were obtained with respect to the value of the initial capacity of the secondary battery of Comparative example 1 including the metal current collector (a copper foil having a thickness of 10 μm) assumed as 100. Similarly, values of the swelling rate and the capacity retention rate are also normalized values that were obtained with respect to corresponding values of the secondary battery of Comparative example 1.

TABLE 1

| | Large-diameter | | Small-diameter | | | | | | | | | |
|---|---|---|---|---|---|---|---|---|---|---|---|---|
| | carbon fiber part | | carbon fiber part | | Covering part | | | | Metal | | | Capacity |
| | | AD1 | | AD2 | | AT1 | M | R | current | Initial | Swelling | retention |
| | Kind | (nm) | Kind | (nm) | Kind | (nm) | (wt %) | (vol %) | collector | capacity | rate | rate |
| Example 1 | CP | 200 | SWCNT | 1 | Si | 55 | 61 | 64 | — | 235 | 22 | 238 |
| Example 2 | CP | 100 | SWCNT | 1 | Si | 27 | 61 | 64 | — | 225 | 16 | 233 |
| Example 3 | CP | 15 | SWCNT | 1 | Si | 4.1 | 59 | 64 | — | 173 | 13 | 218 |
| Example 4 | CP | 10 | SWCNT | 1 | Si | 2.8 | 61 | 64 | — | 182 | 15 | 205 |
| Example 5 | CP | 500 | SWCNT | 1 | Si | 1.5 | 58 | 64 | — | 225 | 20 | 215 |
| Example 6 | CP | 8000 | SWCNT | 1 | Si | 1300 | 40 | 52 | — | 210 | 20 | 231 |
| Example 7 | CP | 8000 | VGCF | 300 | Si | 1300 | 61 | 64 | — | 147 | 26 | 208 |
| Example 8 | CP | 200 | SWCNT | 1 | Si | 70 | 67 | 57 | — | 251 | 38 | 213 |
| Example 9 | CP | 200 | SWCNT | 1 | Si | 96 | 76 | 40 | — | 242 | 83 | 133 |
| Example 10 | CP | 200 | SWCNT | 1 | Si | 26 | 40 | 53 | — | 156 | 8 | 241 |
| Example 11 | CP | 200 | SWCNT | 1 | Si | 33 | 46 | 47 | — | 170 | 20 | 226 |
| Example 12 | CP | 200 | SWCNT | 1 | Si | 47 | 56 | 35 | — | 190 | 50 | 154 |
| Example 13 | CP | 200 | SWCNT | 1 | Si | 55 | 60 | 70 | — | 196 | 18 | 192 |
| Example 14 | CP | 200 | SWCNT | 5 | Si | 58 | 61 | 63 | — | 218 | 41 | 220 |

TABLE 2

| | | | | | Covering part/ | | | | | | | |
|---|---|---|---|---|---|---|---|---|---|---|---|---|
| | Large-diameter | | Small-diameter | | Negative electrode | | | | Metal | | | |
| | carbon fiber part | | carbon fiber part | | active material | | | | current | | | Capacity |
| | | AD1 | | AD2 | | AT1 | M | R | collector | Initial | Swelling | retention |
| | Kind | (nm) | Kind | (nm) | Kind | (nm) | (wt %) | (vol %) | (thickness) | capacity | rate | rate |
| Comparative | — | — | SWCNT | 1 | Si | — | — | 44 | Cu | 100 | 100 | 100 |
| example 1 | | | | | | | | | (10 μm) | | | |
| Comparative | — | — | SWCNT | 1 | Si | — | — | 44 | Cu | 196 | 107 | 64 |
| example 2 | | | | | | | | | (6 μm) | | | |
| Comparative | CP | 5 | — | — | Si | 1.4 | 61 | 64 | — | 132 | 12 | 87 |
| example 3 | | | | | | | | | | | | |
| Comparative | CP | 5 | SWCNT | 1 | Si | 1.4 | 61 | 64 | — | 140 | 18 | 108 |
| example 4 | | | | | | | | | | | | |
| Comparative | CP | 8000 | SWCNT | 500 | Si | 1300 | 61 | 64 | — | 73 | 51 | 123 |
| example 5 | | | | | | | | | | | | |
| Comparative | CP | 200 | SWCNT | 1 | Si | 55 | 61 | 30 | — | 206 | 88 | 69 |
| example 6 | | | | | | | | | | | | |
| Comparative | CP | 200 | SWCNT | 1 | Si | 55 | 61 | 80 | — | 180 | 34 | 106 |
| example 7 | | | | | | | | | | | | |

As indicated in Tables 1 and 2, the initial capacity, the swelling rate, and the capacity retention rate each varied greatly depending on the configuration of the negative electrode. In the following description, respective values of the initial capacity, the swelling rate, and the capacity retention rate in Comparative example 1 are each taken as a comparative reference.

Specifically, when the metal current collector was used, decreasing the thickness of the metal current collector (Comparative example 2) increased the initial capacity, but resulted in an increase in the swelling rate and a decrease in the capacity retention rate.

In contrast, when the large-diameter carbon fiber parts 1, the small-diameter carbon fiber parts 2, and the covering parts 3 were used without using the metal current collector (Examples 1 to 14 and Comparative examples 4 to 7), the initial capacity, the swelling rate, and the capacity retention rate each varied depending on their configurations.

That is, when any of the average fiber diameter AD1, the average fiber diameter AD2, and the void rate R fell outside an appropriate range (Comparative examples 4 to 7), the following two kinds of tendencies were observed. Specifically, although the swelling rate decreased, either the initial capacity or the capacity retention rate decreased. In another case, although the swelling rate decreased and each of the initial capacity and the capacity retention rate increased, the increase in the capacity retention rate was not sufficient.

However, when the average fiber diameters AD1 and AD2 and the void rate R fell within the respective appropriate ranges (AD1: 10 nm to 8000 nm; AD2: 1 nm to 300 nm; and R: 40 vol % to 70 vol %) (Examples 1 to 14), the swelling rate decreased and each of the initial capacity and the capacity retention rate increased, and the increase in the capacity retention rate was sufficient.

In this case, particularly when the weight proportion M was in the range from 40 wt % to 76 wt % both inclusive, the swelling rate decreased sufficiently and each of the initial capacity and the capacity retention rate increased sufficiently. Further, when the average thickness AT was in the range from 2.8 nm to 1300 nm both inclusive, the swelling rate decreased sufficiently and each of the initial capacity and the capacity retention rate increased sufficiently.

Note that when the large-diameter carbon fiber parts 1 and the covering parts 3 were used but no small-diameter carbon fiber parts 2 were used (Comparative example 3), the capacity retention rate decreased although the swelling rate decreased and the initial capacity increased.

### Examples 15 and 16

As described in Table 3, secondary batteries were fabricated and thereafter evaluated for their characteristics (their initial capacity characteristics, swelling characteristics, and cyclability characteristics) in accordance with procedures similar to those for Example 1 except that the surface parts 4 including the ion conductive material were formed in the process of fabricating the negative electrode 32.

As the ion conductive material, lithium phosphorous oxynitride (Li_{3.30}PO_{3.90}N_{0.17}) or lithium phosphate (Li₃PO₄) was used. Note that the average thickness AT2 (nm) of the surface parts 4 was as listed in Table 3.

When forming the surface parts 4, the ion conductive material was deposited onto the surfaces of the covering parts 3 by means of a sputtering method. Note that when forming the surface parts 4 including lithium phosphate, lithium phosphate was used as a target, whereas when forming the surface parts 4 including lithium phosphorous oxynitride, lithium phosphate was used as a target in a nitrogen atmosphere.

TABLE 3

| | | | | | Capacity |
|---|---|---|---|---|---|
| | Surface part | | Initial | Swelling | retention |
| | Kind | AT2 (nm) | capacity | rate | rate |
| Example 1 | — | — | 235 | 22 | 238 |
| Example 15 | Li_{3.30}PO_{3.90}N_{0.17} | 11 | 216 | 33 | 246 |
| Example 16 | Li₃PO₄ | 7 | 208 | 28 | 251 |

As indicated in Table 3, forming the surface parts 4 (Examples 15 and 16) increased the capacity retention rate while helping to minimize a decrease in initial capacity and an increase in swelling rate, as compared with when no surface parts 4 were formed (Example 1).

The results presented in Tables 1 to 3 indicate that when: the negative electrode 32 (the negative electrode 10) included the large-diameter carbon fiber parts 1, the small-diameter carbon fiber parts 2, and the covering parts 3 and had the voids 10G; the large-diameter carbon fiber parts 1 and the small-diameter carbon fiber parts 2 each included the carbon-containing material; the covering parts 3 each included the silicon-containing material; and the appropriate conditions described above were satisfied regarding the average fiber diameters AD1 and AD2 and the void rate R, the initial capacity and the capacity retention rate each increased and the swelling rate decreased. It was thus possible for the secondary battery to achieve a superior initial capacity characteristic, a superior swelling characteristic, and a superior cyclability characteristic.

Although the present technology has been described herein with reference to one or more embodiments including Examples, the configuration of the present technology is not limited thereto, and is therefore modifiable in a variety of suitable ways.

Specifically, the description has been given of the case where the secondary battery has a battery structure of the laminated-film type. However, the battery structure of the secondary battery is not particularly limited, and may be of any other type, such as a cylindrical type, a prismatic type, a coin type, or a button type.

Further, the description has been given of the case where the battery device has a device structure of the stacked type. However, the device structure of the battery device is not particularly limited, and may be of any other type, such as a wound type or a zigzag folded type. In the wound type, the positive electrode and the negative electrode are wound with the separator interposed therebetween. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode including first fiber parts, covering parts, and second fiber parts, the negative electrode having voids; and
an electrolytic solution, wherein
the first fiber parts are coupled to each other to thereby form a three-dimensional mesh structure having the voids, the first fiber parts each including carbon as a constituent element,
the covering parts each cover a surface of corresponding one of the first fiber parts, and each include silicon as a constituent element,
at least some of the second fiber parts are each coupled to a surface of any of the covering parts, the second fiber parts each including carbon as a constituent element,
the first fiber parts have an average fiber diameter that is greater than or equal to 10 nanometers and less than or equal to 8000 nanometers,
the second fiber parts have an average fiber diameter that is greater than or equal to 1 nanometer and less than or equal to 300 nanometers, and
the negative electrode has a void rate that is greater than or equal to 40 volume percent and less than or equal to 70 volume percent.

2. The secondary battery according to claim 1, wherein a proportion of a weight of the covering parts to a sum of a weight of the first fiber parts, the weight of the covering parts, and a weight of the second fiber parts is greater than or equal to 40 weight percent and less than or equal to 76 weight percent.

3. The secondary battery according to claim 1, wherein the covering parts have an average thickness that is greater than or equal to 2.8 nanometers and less than or equal to 1300 nanometers.

4. The secondary battery according to claim 1, wherein a content of silicon in each of the covering parts is greater than or equal to 80 weight percent.

5. The secondary battery according to claim 1, wherein at least some of the second fiber parts are each coupled to two or more of the covering parts.

6. The secondary battery according to claim 1, wherein
the first fiber parts include a carbon paper, and
the second fiber parts each include a single-walled carbon nanotube, a vapor-grown carbon fiber, or both.

7. The secondary battery according to claim 1, wherein
the negative electrode further includes surface parts each provided on a surface of corresponding one of the covering parts, and
the surface parts each include an ion conductive material.

8. The secondary battery according to claim 7, wherein the ion conductive material includes lithium phosphorous oxynitride, lithium phosphate, or both.

9. The secondary battery according to claim 1, wherein the secondary battery comprises a lithium-ion secondary battery.

10. A negative electrode for a secondary battery, the negative electrode comprising
first fiber parts, covering parts, and second fiber parts,
the negative electrode having voids, wherein
the first fiber parts are coupled to each other to thereby form a three-dimensional mesh structure having the voids, the first fiber parts each including carbon as a constituent element,
the covering parts each cover a surface of corresponding one of the first fiber parts, and each include silicon as a constituent element,
at least some of the second fiber parts are each coupled to a surface of any of the covering parts, the second fiber parts each including carbon as a constituent element,
the first fiber parts have an average fiber diameter that is greater than or equal to 10 nanometers and less than or equal to 8000 nanometers,
the second fiber parts have an average fiber diameter that is greater than or equal to 1 nanometer and less than or equal to 300 nanometers, and
the negative electrode has a void rate that is greater than or equal to 40 volume percent and less than or equal to 70 volume percent.
